(19) United States
(12) Patent Application Publication
(10) Pub. No.: US 2016/0007583 A1
(43) Pub. Date: Jan. 14, 2016

(54) Pancake Fishing Sinker

(71) Applicant: Martha E. Jones, Houston, TX (US)

(72) Inventor: James Richard Jones, Houston, TX (US)

(21) Appl. No.: 14/182,883

(22) Filed: Feb. 18, 2014

(51) Int. Cl. A01K 95/00; A01K 99/00

(52) U.S. Cl. CPC A01K 95/00; A01K 99/00

(57) ABSTRACT

A sinker weight adapted to be placed on a fishing hook and a system that is a fishing hook having a sinker weight disposes thereon and means for retaining the sinker weight to the hook. The sinkers are of various shapes but are thin and substantially flat—somewhat like a “pancake”. In the system (rig) they are free to move on the shank of the hook and therefore provide action that can be attractive to fish. They may be easily constructed of non-lead materials.

### BACKGROUND

1. Field of Invention

This invention is a fishing line sinker and fishing rig assembly and more specifically to a sinker weight that attaches to the shaft of a fish hook.

2. Background

“There is an almost infinite variety of sinker weights for fishing lines. Conventional fishing line sinker weights are made and designed to be attached to or suspended from a lead line attached to a hook. Some sinkers are permanently attached to a hook. These various arrangements are adapted to provide a variety on desirable function such as prevention from snagging on weeds, special motion for attracting fish, provides special motion of a lure with sinker attached and the like”. http://en.wikipedia.org/wiki/Fishing sinkers.

While lead sinkers have been the material of choice for sinkers, lead is increasingly being phased out because of toxicity. Lead-based fishing sinkers have been outlawed in the United Kingdom, Canada, and some states in the United States and banned in all of US and Canadian National Parks. As a result, modern sinkers are being constructed of other material such as other dense metals. Tungsten and tungsten allows are gaining popularity since tungsten is much denser than lead.

Most sinkers in use today attach to the line above the hook eye, or are molded permanently to the hook. Some are constructed to slide on the line so that the bait can float somewhat freely after the sinker in on the bottom (this is sometime referred to as a Texas rig). None of these conventional sinkers act as attractants for fish. The present invention solves that problem and provides a unique sinker hook system.

### SUMMARY

The invention is a sinker weight adapted to be placed on a fishing hook. In another embodiment it is system comprising a fishing hook having a sinker weight disposes thereon and means for retaining the sinker weight to the hook. The sinkers are of various shapes but are thin and substantially flat—somewhat like a “pancake”. They are free to move on the shank of the hook and therefore provide action that can be attractive to fish. They may be easily constructed of non-lead materials.

### DESCRIPTION OF FIGURES

A more complete understanding of the sinker and system of the present invention may be had by reference to the following detailed description when taken in conjunction with the accompanying drawings, wherein:

FIG. 1 is perspective view of an embodiment of a sinker of the invention threaded onto the shaft of a fishing hook.

FIG. 2 is perspective view of an embodiment of a sinker system of the invention where plastic bait is threaded onto the shaft of a fishing hook.

FIG. 3 is another perspective view of an embodiment of a sinker system of the invention where plastic bait is threaded onto the shaft of a fishing hook.

FIG. 4 is another perspective view of an embodiment of a sinker system of the invention where plastic bait is threaded onto the shaft of a fishing hook.

FIGS. 5A-E are perspective views of various shapes of sinker embodiments of the invention.

All figures are drawn for ease of explanation of the basic teachings of the present invention only. The exact dimensions and dimensional proportions to conform to specific force, weight, strength, and similar requirements will be within the skill of the art after the following teachings of the present invention have been read and understood.

### DETAILED DESCRIPTION

The present invention, in broad aspect, is a “pancake” shaped fishing line sinker weight for placement on a fishing hook shank. In one embodiment it is system comprising a fishing hook having a sinker weight disposed on the hook shank and means for retaining the sinker weight to the hook. The sinkers generally comprise various shapes but all are thin and substantially flat—somewhat like a “pancake”.

The sinkers may be made of any suitable dense (heavy) material, preferably metal or metal composites. Lead has long been the material of choice but is less desirable now than in the past because of the concern for lead contamination and possible poisoning. Tungsten, tungsten alloys and composites are popular materials since tungsten is nearly twice as dense as lead. Brass, steel and bismuth are also suitable alternatives to lead.

The densities of some of the materials are shown below in Table 1.

TABLE 1

| Material | Density g/cc |
|---|---|
| Steel | 7.75-8.05 |
| Brass | 8.4-8.7 |
| Bismuth | 9.78 |
| Lead | 11.66 |
| Tungsten | 19.25 |

Thus, generally, the density of the material used will be substantially heavier than water (1 g/cc) and should be at least above about 5 g/cc—the higher the better. The material must be sufficiently heavy to sink, in water, both a hook and bait (such as plastic baits) and allow sufficient weight for casting.

The sinkers may be coated. For example, steel will tend to rust but if coated with a polymer coating rusting will be retarded. Moreover, the coating may be colored or patterned as desired. Other metals and high density polymers composites and polymer metal composites (see U.S. Pat. No. 4,949,645) will also be useful in some applications.

In other embodiments the sinkers may be patterned or inscribed—an advantage of the present invention since conventional “barrel” and “ball” sinkers are not easily inscribed. For example, the sinker may be patterned as with ridges, logos, names, attractive patterns and the like. Special patterns and inscriptions will be desirable for fishing tournaments, fishing professionals, marinas and the like.

Generally, the sinker weight will be from about 1/16 to ⅜ ounces (about 1.8 to 3.7 grams) for bass weights and larger and heavier for salt water application. In coastal use the weights may be an ounce or more and for offshore will be even heavier.

The sinkers will be flattened shapes having a face cross section to thickness ratio from about 16:1 to 4:1. Thus a sinker with a cross section (perpendicular to a centerline through the hole) of ½ inch will have a thickness of 1/32 to ⅛ inch. They may also be curved. The sinkers will, in some embodiments, be colored. They may be uncolored (metal color) but may also be colored as desired. It is well known that colored lures attract fish so the colored sinker will also act as an attractant (as will the motion of the sinker) to get the attention of target fish. For example a red colored sinker may fool the fish into thinking it is wounded prey—a common thought for attracting predator fish such as largemouth bass.

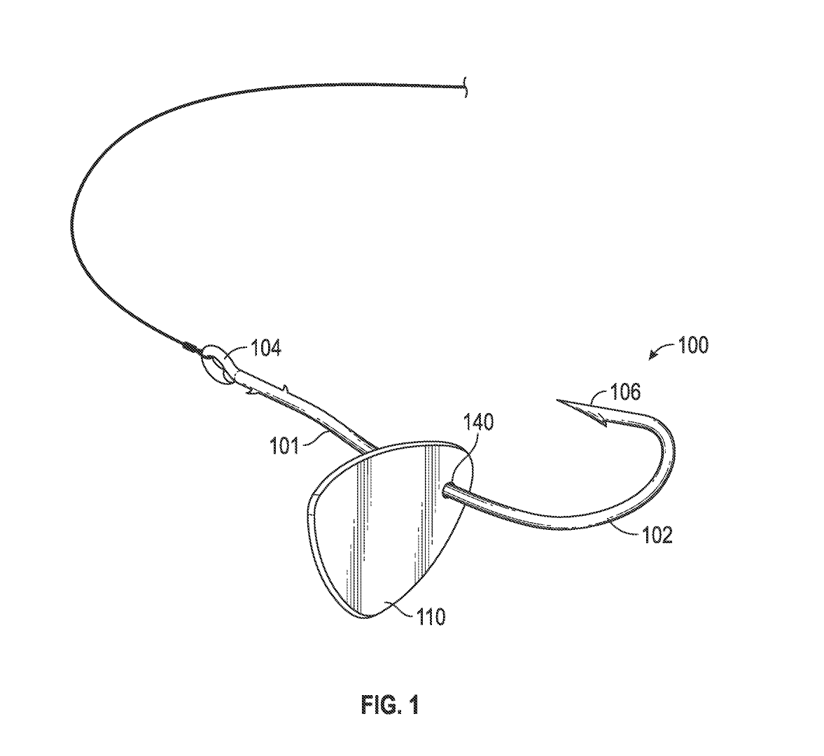

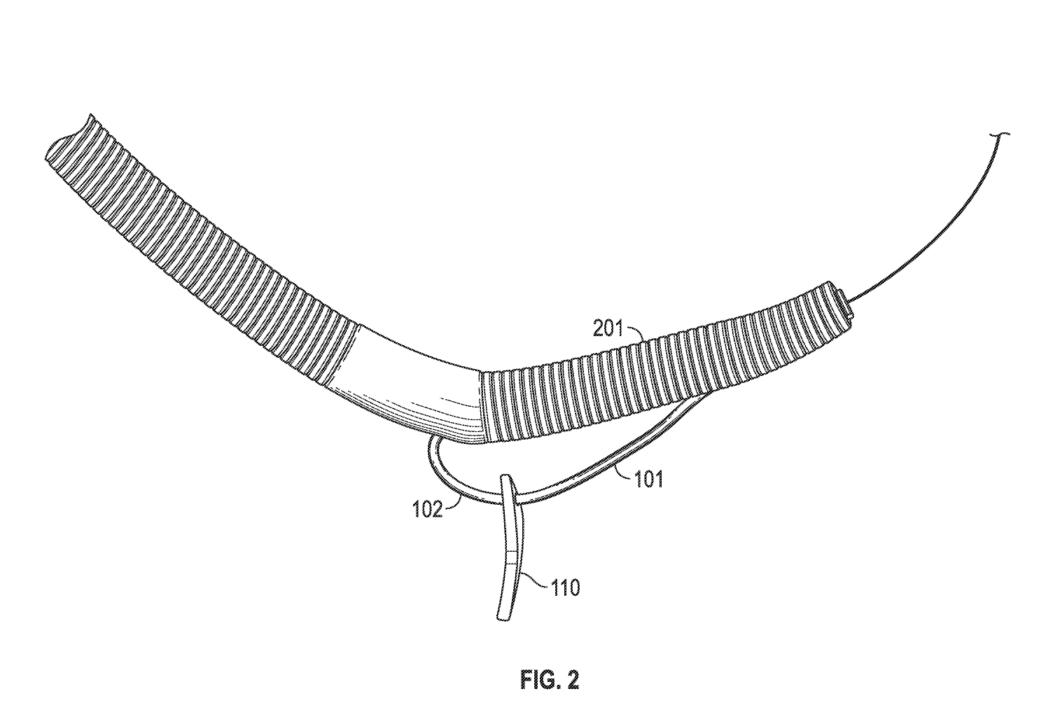

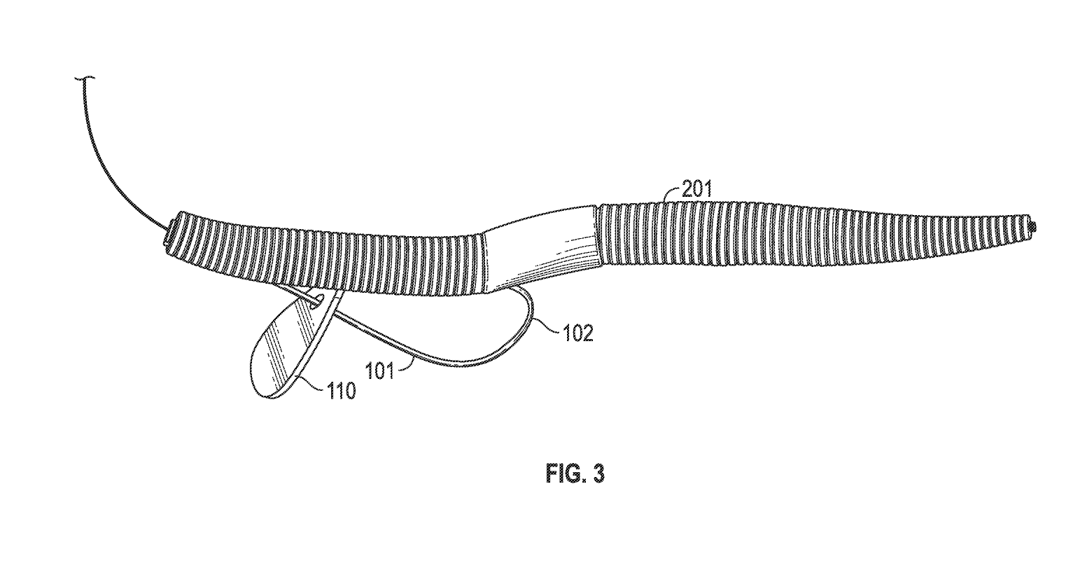

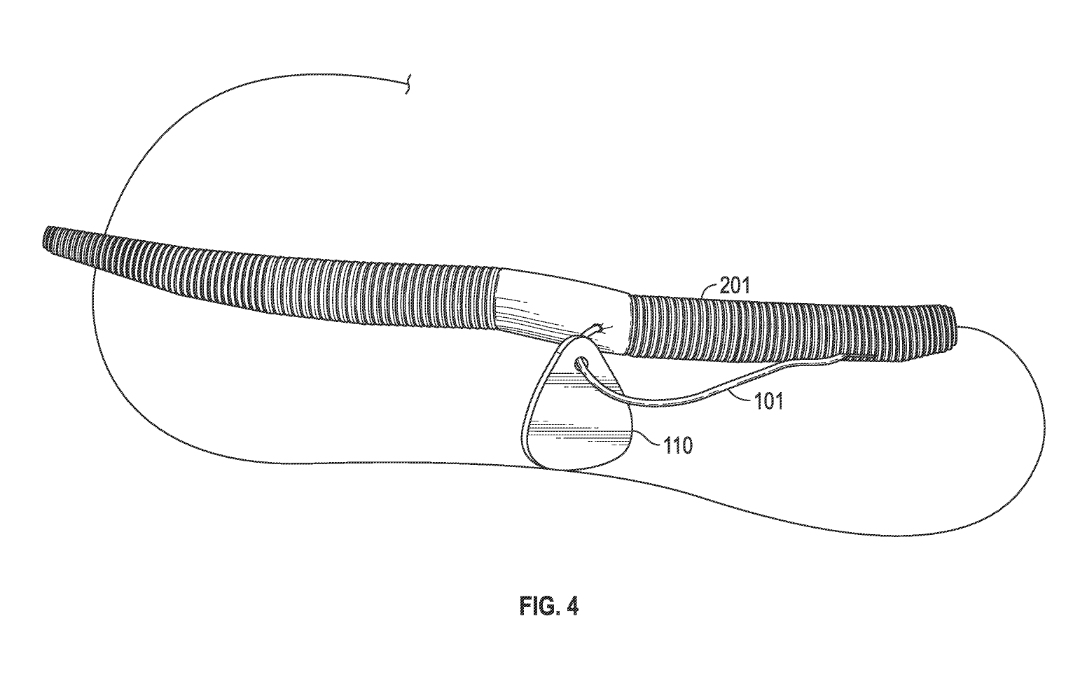

Referring to the Figures, FIG. 1 is a perspective view of a sinker embodiment, 100, of the invention. The sinker, 110, is threaded onto the shank of a fish hook 101. The sinker has a hole, 140, of sufficient size to be threaded over the sharp barbed curved end, 106 of a hook 101. Item 102 is the curve of the hook and 104, the eye for attaching a line. FIGS. 2-4 illustrates the same embodiment but with a plastic worm, 201, also threaded on the hook in a manner to allow substantially all the shank 101 of the hook exposed. The bait 201 serves to keep the sinker from falling off the hook shank. As can be seen in FIGS. 2-4, the plastic bait is threaded on the hook with the hook sharp end, 106, pushed out of the bait very close to the hook eye, the sinker threaded on the hook shank and the sharp end reinserted into the bait. This leaves a substantial section of the hook shank clear so that the sinker is free to slide up and down the shank. This allows the sinker to flutter and wobble as the hook and bait assembly sinks—thus attracting fish by the movement. FIG. 2 shows a side perspective view of the sinker, FIG. 3 a back perspective and FIG. 4 a front perspective.

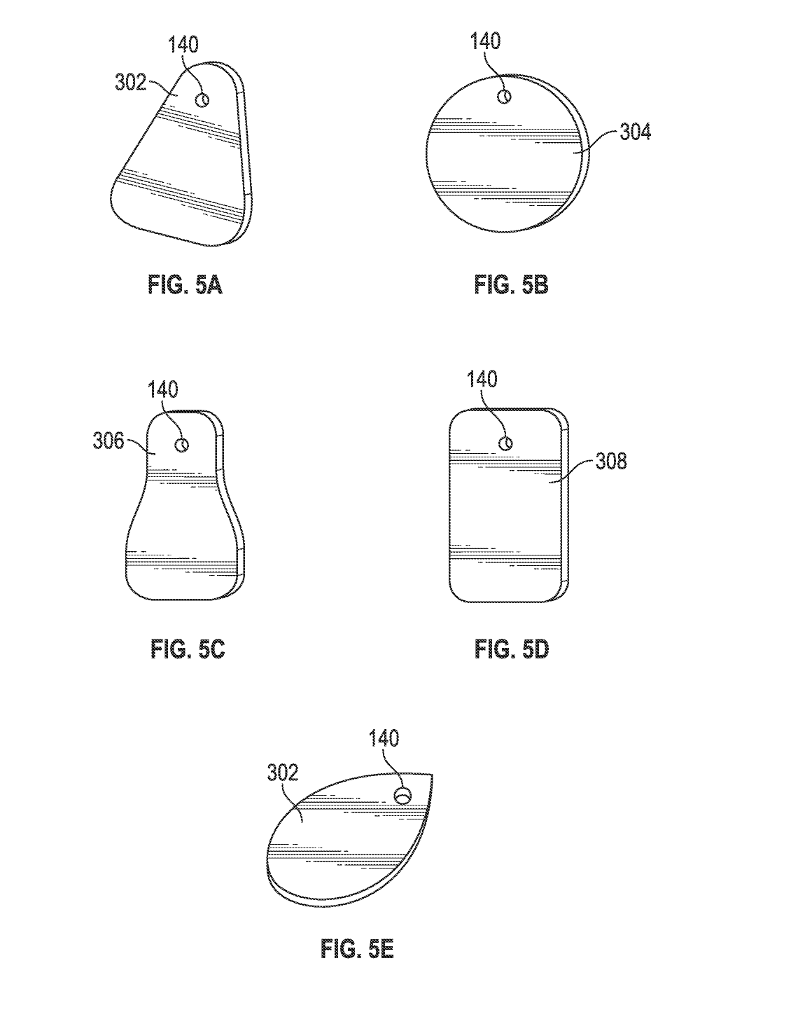

FIG. 5A-E illustrated some, but not all, of the possible shapes for the sinkers. The shape will be determined, inter alia, by the ease of fabrication but more importantly by the desired action to the sinker as the rig sinks. Other shapes will be apparent to those skilled in the art. FIG. 5E shows the relative size to thickness of a typical embodiment.

A prototype of a “bass” rig sinker such as in FIGS. 5A and E, by way of illustration, is about ½ inch in width, ¾ inch long and about 1/16 inch thick. The thickness may be varied depending on the desired weight. The size may be much larger and heavier for saltwater fish.

The sinker may also be configured with a swivel and eye attached to the top of the sinker body so that the eye will be inserted over the hook sharp end. Such a configuration will allow the sinker to spin as it descends.

In other embodiments, the invention is a fishing assembly or “rig” comprising a hook, sinker as described above and means to keep the sinker in place, such as plastic bait. Baits may be of any type such as those shaped as worms, crickets, frogs, salamanders, lizards and the like. Bait other than plastic may also be used to complete the rig and keep the sinker in place, such as pork rinds, live (or previously live) bait and dough. One or more sinkers may be placed on the hook shank depending on the desired weight.

The sinker are conveniently stamped from or cut from sheets of desired metal or dense polymer composite material. For example, the desired shapes of sinker can be stamped from a sheet of metal or the shapes may be cut by computer controlled laser or water cutters. They may also be molded. Holes will be drilled or cut in the appropriate locations.

Although the invention hereof has been described by way of specific embodiments, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

1. A sinker weight for weighting a fishing hook comprising a shaped structure having a thickness dimension substantially less the face cross section dimension and having a hole near one side and having a density of at least 5 g/cc.

2. The sinker of claim 1 wherein the shaped structure is pear shaped with the hole in the narrow end.

3. The sinker of claim 1 wherein the sinker is constructed of material selected from the group consisting of lead, steel, brass, tungsten, tungsten composite, tungsten allow, high density polymer, and combinations of the above.

4. The sinker of claim 1 wherein the sinkers are flattened shapes having a face cross section to thickness ratio from about 16:1 to 4:1.

5. The sinker of claim 1 wherein the sinker is colored

6. The sinker of claim 1 wherein the sinker is coated with a colored protective coating.

7. The sinker of claim 1 wherein the sinker is patterned and/or inscribed.

8. A fishing assembly comprising:
a fish hook having a sharp end, a shank and an eye;
sinker weight a shaped structure having a thickness dimension substantially less the face dimension with a hole near one side and having a density of at least 5 g/cc disposed on the shank of the hook;
a removable means for preventing the sinker from coming off the shank of the hook.

9. The assembly of claim 8 wherein the shaped structure of the sinker is shaped in a pear shape with the hole in the narrow end.

10. The assembly of claim 8 wherein the sinker is constructed of material selected from the group consisting of lead, steel, brass, tungsten, tungsten composite, tungsten allow, high density polymer, and combinations of the above.

11. The assembly of claim 8 wherein the sinkers are flattened shapes having a face cross section to thickness ratio from about 16:1 to 4:1.

12. The assembly of claim 8 wherein the sinker is colored.

13. The assembly of claim 8 wherein the sinker is coated with a colored protective coating.

14. The sinker of claim 1 wherein the sinker is patterned and/or inscribed.

15. A kit comprising
a fish hook having a sharp end, a shank and an eye;
sinker weight a shaped structure having a thickness dimension substantially less the face dimension with a hole near one side and having a density of at least 5 g/cc disposed on the shank of the hook;
a removable means for preventing the sinker from coming off the shank of the hook.

16. The kit of claim 17 wherein the sinker is colored or coated with a colored protective coating and is inscribed or patterned.
